(19) United States
(12) Patent Application Publication
(10) Pub. No.: US 2011/0047059 A1
(43) Pub. Date: Feb. 24, 2011

(54) Residential mortgage exchange and borrower trading platform

(76) Inventor: Eric Manley, New York, NY (US)

Correspondence Address: Eric Manley, 129 E 82nd St #6c, New York, NY, 10028, US

(21) Appl. No.: 12/460,589

(22) Filed: Jul. 22, 2009

Related U.S. Application Data
(60) Provisional application No. 61/086,591, filed on Aug. 6, 2008.

(51) Int. Cl. G06Q 40/00

(52) U.S. Cl. 705/37; 705/38; 705/35

(57) ABSTRACT

R-M-X is an online platform design and utility to allow borrowers to search for and execute mortgage loan alternatives across a pool of lenders. R-M-X will allow borrowers and lenders to enter into standardized loans through R-M-X rather than directly as bilateral agreements. Each mortgage will be bifurcated into a credit and funding component. Borrowers and lenders can each separately manage the credit and funding components of the loan. Also, R-M-X will act as a primary and secondary trading exchange and clearing entity for collateral and funding lenders providing trading, clearing and standardization for retail liabilities including residential mortgages.

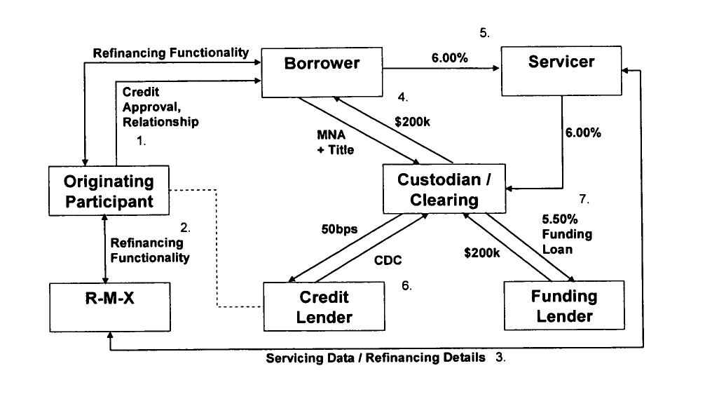

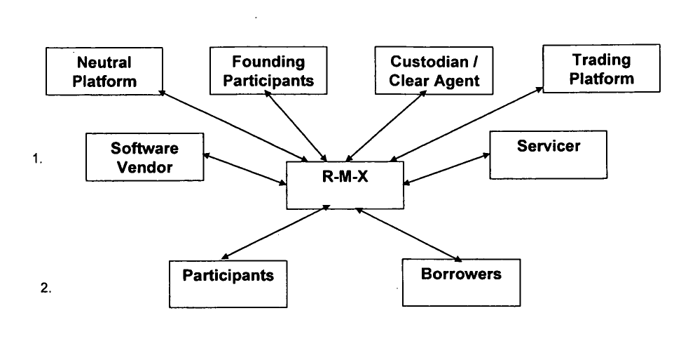

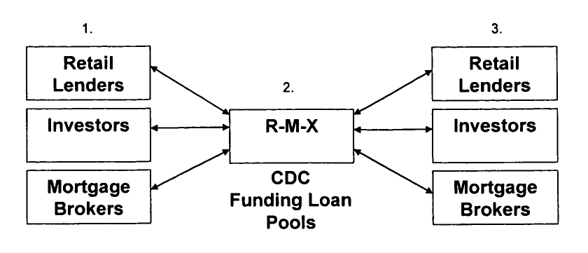

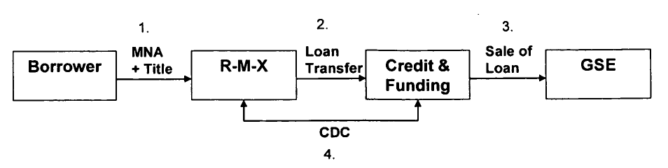

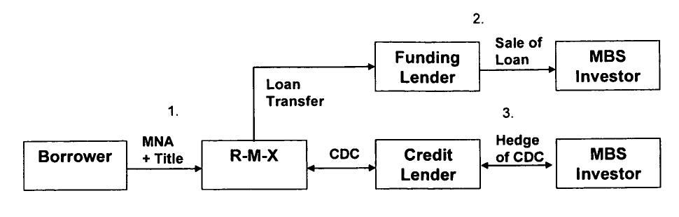

### CROSS-REFERENCE TO RELATED APPLICATIONS

Provisional application No. 61/086,591 filed on Aug. 6, 2008; application Ser. No. 12/460,589 provided on Aug. 10, 2009

### STATEMENT REGARDING FEDERALLY SPONSORED RESEARCH OR DEVELOPMENT

NA

### REFERENCE TO SEQUENCE LISTING, A TABLE, OR A COMPUTER PROGRAM LISTING COMPACT DISC APPENDIX

NA

### BACKGROUND

Eric Manley has created a new process to address the issues with the residential mortgage market as a result of the 2008-9 financial crisis. Key constituents in the residential mortgage market are looking for a better approach to transact business and manage risks:
Originators: increase retention and profitability of customer relationships
Investors: enhance liquidity and transparency as well as improve management of risks
Borrowers: improve ability to manage mortgage loan liability and reduce transaction costs
Regulators: improve transparency and organization of market to be able to monitor transaction flows and risk levels as well as facilitate broad regulatory reforms

Eric Manley has 20 years of Wall Street experience in capital markets, structured finance and investment banking.

### SUMMARY

The Residential Mortgage Exchange and Borrower Trading Platform (R-M-X) is the design, process and functionality for an electronic trading exchange for residential mortgage lenders (Exchange Platform) and an executable mortgage loan trading and liability management platform for borrowers (Borrower Platform). R-M-X acts as the bilateral counterparty between lenders and borrowers to facilitate trading, clearing and continuity.

### DESCRIPTION OF INVENTION

Key elements of the invention include the combination and use of the following:
1. Master note agreement that provides for the issuance of a variety of note types to facilitate modification and refinancing
2. Bifurcation of loans, directly or synthetically, into credit and funding components
3. Book entry or depositary process for loan record keeping and tagging
4. Electronic platform for institutional origination, trading and pooling that provides posting, analytics and order execution
5. Clearing arrangement that provides mark to market of loan exposure, margin posting, risk management, clearing of trades and netting of exposure
6. Executable borrower platform that provides liability management capabilities including the ability to refinance, roll over and modify loans across funding providers via a trade execution
7. Integrated platform and process that links borrowers, lenders, financial institutions, servicers, trading platform, custodian/clearing agent and software providers

Borrower Platform: R-M-X is an online platform design and utility to allow borrowers to search for and execute mortgage loan alternatives across a pool of lenders. R-M-X will allow borrowers and lenders to enter into standardized loans through R-M-X rather than directly as bilateral agreements. Each mortgage will be bifurcated into a credit and funding component. R-M-X will enter into upfront arrangements with banks or other financial institutions to provide credit default contracts (CDCs) and/or loans (Funding Loans). CDC provides continuity of credit to allow the borrower to refinance its Funding Loan on a real time basis without a new credit review process. Borrowers will enter into a master note agreement (MNA) with R-M-X. Through the MNA, the borrower will be able to enter into loans with various maturities, call features, interest rate modes, currencies and payment features. Further, the borrower will be able to enter into these arrangements based on a trade execution rather than a formal closing. Borrower flexibility will be limited indirectly by the CDC. R-M-X will utilize a book entry or depository process for the MNA and the property title as well as act as clearing agent for payments. CDC will be a standardized contract under which the Collateral Lender assumes the default and recovery risk of the borrower. R-M-X will seek to neutralize the credit risk of Collateral Lenders in making payments under the CDC to Funding Lenders through certain credit measures and clearing activities. Upon a borrower default, the Collateral Lender will pay par to the Funding Lender.

For new loans, R-M-X will provide a matching service for a Collateral Lender based on the borrower's credit profile and proposed loan terms. For existing loans, the lender will convert the existing loan format to the R-M-X MNA along with computing a credit spread and funding rate based on the original funding terms. Borrowers will also be able to make reverse inquiries in that they can post new or existing loan terms as well as credit metrics to solicit competitive terms from participants.

Exchange Platform: R-M-X will act as a primary and secondary trading exchange for Collateral and Funding Lenders providing trading, clearing and standardization for retail liabilities including residential mortgages. R-M-X's design and process will provide market data, trading data, analytical screens, trading interface as well as administrative features. Trades will be matched and executed and payments will be cleared. R-M-X will have a process to ensure trades are cleared, including: participant credit and financial requirements, credit maintenance requirements and open positions will be marked to market and maintenance margin requirements will be posted. Pre-trade functions will include: availability of historical and real time data, price discovery, research/analysis, view participant inventory and identify buyers/sellers. Trade functions will include: single, multiple and cross trades. Post-trade functions will include: trade matching and clearing.

### Additional Details:

### New Loan Origination:

Borrowers would seek the R-M-X loan through a bank's or broker's web site, branch, telephone, etc. Credit review and underwriting process will be the same as today. Upon credit approval, Credit Loan and Funding Loan will be provided by participant through the MNA structure. Enhanced loan will be subsequently “listed” on the platform to provide functionality. Via their web site and branches, banks and brokers will enable their customers to manage their loan. Also, R-M-X's functionality will be available through certain neutral platforms to provide a matching service for a Credit Lender based on the borrower's credit profile and proposed loan terms. Matched Credit Lenders will review and approve credit. Borrower can search for desirable Funding Loan or accept one from Credit Lender if offered.

### Transfer of Existing Loans:

If a borrower's existing lender is an R-M-X participant, the lender will need to convert the existing loan format to the R-M-X MNA along with computing a credit spread and funding rate based on the original funding terms. If rates have dropped, the lender can concurrently offer a new credit spread and/or funding rate. If the existing lender is not an R-M-X participant or the lender doesn't want to allow a transfer then if rates have dropped, R-M-X can arrange a new loan, the proceeds of which will be used to repay the existing loan. If rates have increased, R-M-X can through the exchange, see if the existing lender will accept a take out at market (discount to par) and if so R-M-X will concurrently arrange a new loan and set up the borrower's account so that their credit profile has been vetted and allow the borrower to quickly execute a new loan when rates drop or other terms improve.

### Purchase of Loans by Borrowers:

As an alternative to rate refinancing, R-M-X will help borrowers benefit from a drop in the market value of their loan versus par. Sophisticated borrowers can post a bid along with other participants to purchase their loan just like corporations in the bond and stock markets. Alternatively, borrowers can enter into a hedge or synthetic instrument rather than purchasing the actual underlying loan.

### Clearing and Credit Measures:

R-M-X will match and settle all trades and guarantee creditworthiness of every trade ensuring safety and soundness. R-M-X will seek to neutralize the credit risk of Credit Lenders in making payments under the CDC to Funding Lenders through certain credit measures and clearing activities:
Performance guarantee
Initial and maintenance margin requirements
Mark to market of CDC exposure
Master setoff with other positions
Exposure limitations
CDC secured by underlying property title
Assessment against all participants for ultimate non payment

As a result, a borrower's Funding Loan terms will not be impacted by the credit profile of the Credit Lender and their risk of payment upon a default. Similarly, the Funding Lender will rely on R-M-X and its clearing and credit process rather than the counterparty of the CDC for repayment. Funding Loan terms will be generic and reflect prevailing market levels.

R-M-X will apply a master valuation and mark to market process that will apply to all participants that have outstanding CDCs. R-M-X will use a combination of dealer bids, implied valuations, valuation models and trading activity. R-M-X will utilize a sophisticated approach involving statistical analysis/forecasting, option pricing and simulation as well as modify its approach as needed over time. As a result of the integrated platform, R-M-X will be able to utilize key data including delinquency information from servicers as well as tap into new and existing technologies for tracking credit changes, appraisals and demographics. CDCs will be more homogeneous than current loans and will be based on current underwriting standards. R-M-X through its custodian will mange collateral posting and releasing for participants based on the MTM process.

### CDC Features:

CDC will be a standardized contract under which the Credit Lender assumes the default and recovery risk of the borrower. CDC is similar to a credit default swap. Credit Lender will perform upfront and, as needed, ongoing credit review of the borrower. Credit Lender will be paid a periodic fee (i.e., credit spread). Based on the borrower's credit, the CDC will be for a specified term and have certain funding limitations which will be reflected in the MNA. CDC may have certain call or other structural protections for the Credit Lender. Upon a borrower default, the Credit Lender will pay par to the Funding Lender via R-M-X.

### Funding Loan Features:

R-M-X via the Funding Lender will provide loan alternatives based on the terms and limitations of the CDC. CDC will determine maturity limit of Funding Loan as well as may limit certain loan features and options depending on the Credit Lender's credit review of the borrower. Funding loan terms may include the following:
Fixed, floating, step ups, caps, floors
Various tenors—1, 2, 5, 10, 30 years
Call option features
Currencies
Interest and payment features

### MNA Features:

MNA will be an agreement between the borrower and R-M-X and will have terms similar to a corporate medium term note program. NINA will allow a borrower to change interest rate, maturity and other loan terms based on a trade execution rather than a formal closing. R-M-X can also allow a borrower to purchase their loan at a discount to par subject to certain limitations. Borrower flexibility will be limited indirectly by the CDC and the Credit Lender's credit review and approval of the borrower. R-M-X will utilize a book entry or depository process for the MNA and the property title as well as act as clearing agent for payments. Upon a borrower default, R-M-X will transfer the MNA and property title to the Credit Lender for recovery. MNA will have terms for the credit spread as well as funding loan.

### Borrower Features:

The invention provides unique features to borrowers:
Improved liability management capability
   Borrowers can capture improved market terms and add triggers and execution functions
   R-M-X can also allow a borrower to purchase their loan at a discount to par subject to certain limitations
   Ability to transport Funding Loan to replacement home
Through R-M-X's functionality, a borrower can evaluate and execute competitive products across many lenders
No additional credit approval needed in many cases
   Upfront approval provides pre approval for certain changes (e.g., reduction of interest rate with same term and structure)
   More complex changes may require credit approval
Reduced fees and expenses as well as faster execution
No or very limited closing costs for refinancings
Tailored rather than generic disclosure and better analytics

### Originator Features:

The invention provides unique features to originators:
Novel product should lead to increased originations and revenues for originators
   Complementary to existing brand and marketing efforts
   Loan structure enhanced versus standard products
   Applicable for new as well as existing loans
   Platform allows faster roll out of loan capacity and/or new products
   Possible increase in refinancing fees and use of higher margin products
R-M-X's book entry/depositary process and standardized MNA should allow for cost reductions and greater efficiency
R-M-X provides an opportunity for participants to facilitate regulatory reform
Tailored disclosure possible with interactive online platform
For loans originated through R-M-X, there should be a drop in origination costs

### Participant Features:

The invention provides unique features to participants:
CDCs and Funding Loans should provide interesting securitization, trading and arbitrage strategies for trading desks
R-M-X will also facilitate creation and trading of pools, tranches, securitizations and derivatives as well as sale to government sponsored entities (GSEs)
Exchange provides a number of benefits to participants
   Liquidity, competitive prices
   Transparency
   Neutralizes counterparty risk
   Clearing
   Greater access to loans
   Inventory management
   Reduced administrative costs
   Information services
Also, R-M-X provides an opportunity for participants to facilitate regulatory reform

### Credit Lender Features:

The invention provides unique features to Credit Lenders:
Credit risk issues unchanged
   Credit Lender will review and approve borrower's credit (the same as today)
   Enhanced ability to refinance will improve the credit of the borrower and therefore the Credit Loan
   MNA limitations will restrict loan alternatives based on a borrower's credit profile as approved by Credit Lender
No upfront cash loan provides levered return profile and improves return on assets and other financial metrics
Provides longer term customer and credit relationship that transcends funding in place
   Prepay risk possible but more limited in that borrower may have to seek new credit review and home appraisal
   Credit Lender's branches and web site will continue to maintain relationship with borrower—R-M-X capabilities provided through technology link
Servicer revenue quality enhanced since it is tied to customer relationship and not subject to interest rate related prepayments

### Funding Lender Features:

The invention provides unique features to Funding Lenders:
Credit risks simplified and based on generic CDC terms and mitigated through R-M-X's credit measures
Refinancing risk essentially unchanged although execution is simplified and costs are lower for the borrower
   However, Funding Loans with call protection may improve returns for Funding Lenders
R-M-X will match and parse out loan capacity by product offering across borrowers
Similar to current mortgage products, Funding Loans will provide a spread to Treasury securities and facilitate cash management needs for investors
   New products will create trading and arbitrage opportunities for institutions
   Funding Loan is a private market version of agency securities
New product provides opportunity for Funding Lender to apply securitization expertise and use their diverse funding sources (ex., conduits)

### Diagrams:

### View 1—Simplified Transactional Flows:

R-M-X will be the bilateral counterparty for borrowers and lenders to facilitate origination, refinancing, trading and securitization. Description of the diagram is as follows:
1. After credit approval and formation of a customer relationship with the Originating Participant, the Borrower will have refinancing functionality regarding their mortgage loan or other financial product.
2. Originating Participant will be able to execute the refinancing functionality via the R-M-X platform.
3. R-M-X will have a relationship with the Servicer to provide and receive necessary data.
4. Custodian/Clearing will hold title to the loan and transfer the upfront proceeds to the Borrower which it will receive from the Funding Lender. Custodian will also receive the loan payments from the Servicer and make payments to the Credit Lender and Funding Lender.
5. Servicer will send bills to the Borrower and make collections and remit them to the Custodian/Clearing as well as transmit data to R-M-X.
6. Credit Lender will issue the CDC and receive a premium from the Custodian/Clearing.
7. Funding Lender will provide the upfront loan to the Custodian in return for the Funding Loan.

### View 2—Simplified Organizational Diagram:

R-M-X will leverage existing capabilities via an outsourced partnership model with a concurrent organizational formation and closing. Description of the diagram is as follows:
1. Partners include: Neutral Platform, Founding Participants, Custodian/Clearing, Software Vendors, Trading Platform and Servicers.
2. Customers include: Participants and Borrowers.

### View 3—Exchange and Trading Diagram:

R-M-X will provide an exchange platform and clearing arrangement for participants. R-M-X will provide market data, trading data, analytical screens, trading interface as well as administrative features. Trades will be matched and executed and payments will be cleared. R-M-X will aim to improve liquidity and transparency as well as reduce transaction costs for participants. Large and small institutions will be able to compete on the same basis. Description of the diagram is as follows:
1. Various parties will originate trades and exchanges as buyers.
2. R-M-X will facilitate the trading, exchange, research, evaluation and analysis of trades, exchanges and structures.
3. Various parties will originate trades and exchanges as sellers.

### View 4—Sale to GSE Diagram:

R-M-X will facilitate the repackaging and sale of loans to government sponsored entities (GSE). Description of the diagram is as follows:
1. MNA and title for loan will be held by R-M-X.
2. R-M-X will transfer loan to Credit & Funding Provider.
3. Credit &Funding Provider will sell loan to GSE for further sale to investors.
4. Credit Provider will retain CDC between R-M-X and Credit Provider but the credit exposure is hedged via the sale of loan to the GSE.

### View 5—Securitization Diagram:

R-M-X will facilitate the securitization of the Funding Loan and CDC. Description of the diagram is as follows:
1. MNA and title for loan will be held by R-M-X.
2. Funding Lender will repackage loans and sell them as mortgage backed securities (MBS) to MBS Investors.
3. Credit Lender will repackage the CDC and sell them via a hedge type transaction to MBS Investors.

Based on the details herein, the applicant believes this is a proprietary business method and that its design/flow, features, algorithms, functionality and use should be subject to patent protection. Specifically, the applicant is claiming the following features, provisions and applications:

1. Design, features, functionality and use of online and electronic executable platform for retail oriented liability management including residential mortgage loans

2. Design, features, functionality and use of online and electronic trading exchange and clearing process for buying/selling retail oriented liabilities including residential mortgage loans

3. Design, terms, functionality and use of Credit Default Contact (as defined herein) and the bifurcation of credit and funding for retail liabilities including residential mortgage loans

4. Design, terms, functionality and use of Funding Loan (as defined herein) for retail liabilities including residential mortgage loans

5. Design, terms, functionality and use of Master Note Agreement (as defined herein) for retail liabilities including residential mortgage loans

6. Integration of the foregoing design, features, functionality and use that links borrowers, lenders, financial institutions, servicers, trading platforms, custodian/clearing agent and software providers into an organized process, relationship, risk management and cash flow mechanics for retail liabilities including residential mortgage loans
